(19) United States
(12) Patent Application Publication
(10) Pub. No.: US 2006/0156081 A1
(43) Pub. Date: Jul. 13, 2006

(54) Semiconductor component test procedure, as well as a data buffer component

(75) Inventor: Thorsten Bucksch, Munchen (DE)

Correspondence Address: MORRISON & FOERSTER LLP, 1650 TYSONS BOULEVARD, SUITE 300, MCLEAN, VA, 22102, US

(73) Assignee: Infineon Technologies AG, Munchen (DE)

(21) Appl. No.: 11/115,390

(22) Filed: Apr. 27, 2005

(30) Foreign Application Priority Data
Apr. 28, 2004 (DE) 10 2004 020 866.2

(51) Int. Cl. G11B 20/20; G06K 5/04; G11B 5/00

(52) U.S. Cl. 714/700

(57) ABSTRACT

A data buffer component and a semiconductor component test procedure for testing a memory module are provided. At least one memory component with a series-connected buffer is included. The procedure includes testing the memory module by using a pulse signal, which has been chronologically retarded or advanced by a predetermined time period in comparison with the memory module during normal operation.

### CLAIM FOR PRIORITY

This application claims priority to German Application No. 10 2004 020 866.2, filed Apr. 28, 2004, which is incorporated herein, in its entirety, by reference.

### TECHNICAL FIELD OF THE INVENTION

The invention relates to a semiconductor component test procedure, as well as to a data buffer component.

### BACKGROUND OF THE INVENTION

Semiconductor components, e.g. corresponding integrated (analog and/or digital) computer circuits, semiconductor memory components such as for instance function memory components (PLAs, PALs, etc.) and table memory components (e.g. ROMs or RAMs, particularly SRAMs and DRAMs), etc. are subjected to numerous tests during the course of the manufacturing process.

For the simultaneous manufacture of numerous (generally identical) semiconductor components, a so-called wafer (i.e. a thin disk consisting of monocrystalline silicon) is used. The wafer is appropriately processed (e.g. subjected to numerous, coating, exposure, etching, diffusion and implantation process steps, etc.), and subsequently sawn up (or e.g. scored and snapped off), so that the individual components are made available.

During the manufacture of semiconductor components (e.g. DRAMs (Dynamic Random Access Memories and/or dynamic Read/Write memories), particularly of DDR-DRAMs (Double Data Rate-DRAMs and/or DRAMs with double data rate)) the components (still on the wafer and incomplete) may be subjected to corresponding test procedures (e.g. the so-called kerf measurements at the scoring grid) at one or several test stations by means of one or several test apparatuses even before all the required above processing steps have been performed on the wafer (i.e. even while the semiconductor components are still semi-complete).

After the semiconductor components have been completed (i.e. after all the above wafer processing steps have been performed) the semiconductor components are subjected to further test procedures at one or several (further) test stations; for instance the components, still present on the wafer and completed, may be tested with the help of corresponding (further) test apparatuses (“disk tests”).

In similar fashion, several further tests may be performed (at corresponding further test stations and by using corresponding further test equipment) e.g. after the semiconductor components have been installed in corresponding semiconductor-component housings, and/or e.g. after the semiconductor component housings (together with the semiconductor components installed in them) have been installed in corresponding electronic modules (so-called “module tests”).

During testing, the semiconductor components (e.g. during the above disk tests, module tests, etc.), may be subjected to so-called “DC tests” and/or e.g. so-called “AC tests” as test procedures.

During a DC test, for instance, a voltage (or current) at a specific, in particular a constant, level may be applied to corresponding connections of a semiconductor component to be tested, whereafter the level of the resulting currents (and/or voltages) are measured, in particular tested to see whether these currents (and/or voltages) fall within predetermined required critical values.

During an AC test in contrast, voltages (or currents) at varying levels, particularly corresponding test model signals, may for instance be applied to the corresponding connections of a semiconductor component, with the help of which appropriate function tests may be performed on the semiconductor component in question.

With the aid of above test procedure defective semiconductor components and/or modules may be identified and then sorted out (or else partially repaired), and/or the process parameters, applied during the manufacture of the components in each case, may be appropriately modified and/or optimized, in accordance with the test results achieved, etc., etc.

In case of numerous applications, e.g. at server or work station computers, etc., etc., memory modules with data buffer components (so-called buffers) connected in series, e.g. so-called “buffered DIMMs”, may be used.

Similar memory modules generally contain one or several semiconductor memory components, particularly DRAMs, as well as one or several data buffer components, connected in series before the semiconductor memory components, (which may for instance be installed on the same card as the DRAMs).

The memory modules are connected, particularly when a corresponding memory controller has been connected in series (e.g. arranged externally to the memory module in question), with one or several micro-processors of a particular server or work station computer, etc.

In partially buffered memory modules, the address and control signals of corresponding data buffer components, e.g. emitted by the memory controller, or by the processor in question, may be (briefly) retained and then relayed, in chronologically coordinated, or where appropriate, in de-multiplexed fashion, to the memory components, e.g. DRAMs.

In contrast, the (useful) data signals emitted by the memory controller and/or by each processor may be directly, i.e. without being buffered by a corresponding data buffer component (buffer), relayed to the memory component (and, conversely, the (useful) data signals directly emitted by the memory components may, without a corresponding data buffer component (buffer) being connected in series, be relayed to the memory controller and/or to each processor).

With “fully buffered” memory modules in contrast, the address and control signals exchanged between the memory component (and/or each processor) and the memory controller, and also the corresponding (useful) data signals of corresponding data buffer components may first be retained, and only afterwards relayed to the memory component and/or the memory controller or to each processor.

If the above fully or partially buffered memory modules are subjected to a corresponding module test, particularly a module function test, the problem arises that the test signals, particularly the test model signals emitted by the corresponding test apparatus are totally or partially decoupled from the memory component by the series-connected data buffer components.

This has the effect that particular parameters of the memory component, e.g. the “input setup” and “input hold” tolerances, may be not be able to be tested at all and if so, then only inadequately.

### SUMMARY OF THE INVENTION

The invention is directed to making available a novel semiconductor component test procedure, as well as a novel data buffer component.

According to an embodiment of the invention, a semiconductor component test procedure for testing a memory module with at least one memory component with series-connected buffer is provided. The procedure includes testing the memory module by using pulse signals (CK, CK#), chronologically advanced or retarded by a predetermined time period (τ, +τ1) in comparison with the memory module during normal operation.

According to a further embodiment of the invention, a data buffer component is provided which may be connected in series in front of a memory component. The data buffer component may include a device for generating a pulse signal (CK, CK#), which device can be switched over from the normal operational mode to a test operational mode, whereby the pulse signal (CK, CK#) has been chronologically advanced or retarded by a predetermined time period (τ, +τ1) during the test operational mode in comparison with the normal operational mode.

Advantageously, the data buffer component contains a device, e.g. a DLL circuit, with which the pulse signal (CK, CK#) may be chronologically displaced while in the test operational mode.

### BRIEF DESCRIPTION OF THE DRAWINGS

Preferred embodiments of the invention are explained in more detail below with reference to the accompanying drawings, in which:

FIG. 1 is a schematic representation of a partially buffered memory module, with corresponding memory components, and corresponding data buffer components;

FIG. 2 is a schematic representation of a fully buffered memory module, with corresponding memory components and corresponding data buffer components; and

FIG. 3 is a schematic detail representation of a data buffer component used in the memory module in terms of FIGS. 1 and/or 2, which component could be used for performing a semiconductor component test procedure according to an embodiment of the invention.

### DETAILED DESCRIPTION OF THE INVENTION

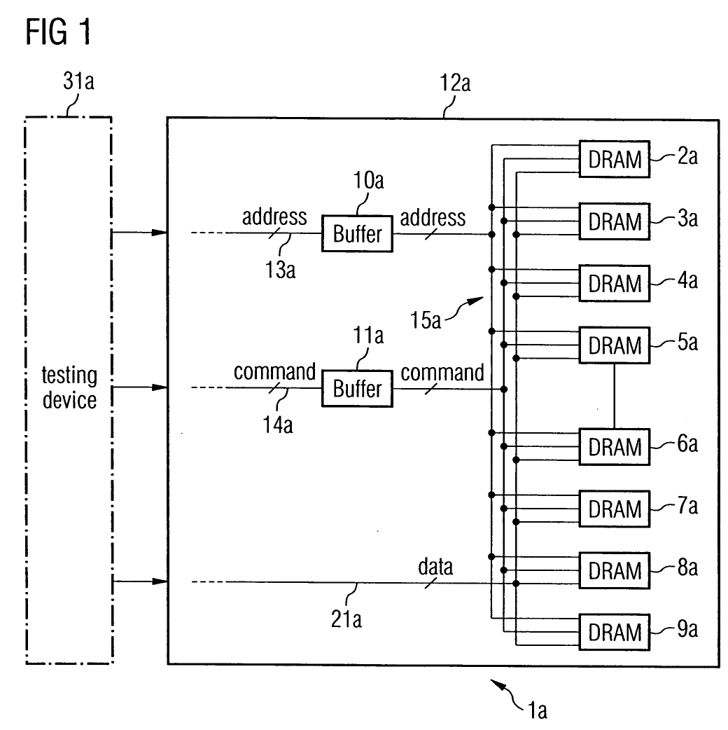

In FIG. 1 a schematic representation of a partially buffered memory module 1a (here: a “buffered DIMM” 1a) is shown.

FIG. 1 contains numerous memory components 2a, 3a, 4a, 5a, 6a, 7a, 8a, 9a, and, connected in series before the memory components 2a, 3a, 4a, 5a, 6a, 7a, 8a, 9a, several (here: two) data buffer components (“buffers”) 10a, 11a.

The memory components 2a, 3a, 4a, 5a, 6a, 7a, 8a, 9a may, for instance, be function storage or table memory components (e.g. ROMs or RAMs), particularly DRAMs.

As is apparent from FIG. 1, the memory components 2a, 3a, 4a, 5a, 6a, 7a, 8a, 9a may be arranged on the same card 12a as the buffer 10a, 11a.

The memory module la may be connected, particularly with a corresponding memory controller connected in series (e.g. one installed externally to the memory module 1a, in particular one installed externally to the above card 12a and not shown here), with one or several micro-processors, particularly with one or several micro-processors of a server or work station computer (or of any other suitable micro-processor, e.g. a PC, laptop, etc.).

As is apparent from FIG. 1, with the partially buffered memory module 1a the address, and control, signals, for instance, emitted by the memory controller or the processor in question, are not directly relayed to the memory components 2a, 3a, 4a, 5a, 6a, 7a, 8a, 9a.

Instead, the address signals are first relayed to the buffers 10a, 11a, for instance, via a corresponding address bus 13a, and the control signals for instance via a corresponding control bus 14a (e.g. the address signals, via the address bus 13a, to buffer 10a, and the control signals, via the control bus 14a, to buffer 11a).

The control signals may be any suitable control signals as used in conventional memory modules, e.g. corresponding read and/or write, and/or chip select (memory component selection) signals, etc.

In the buffers 10a, 11a, the corresponding signals (address signals, control signals) are briefly buffered, and relayed in a chronologically coordinated, or where needed, demultiplexed fashion to the memory components 2a, 3a, 4a, 5a, 6a, 7a, 8a, 9a (e.g. via a corresponding central memory bus 15a).

With the partially buffered memory module la shown in FIG. 1 in contrast, the (useful) data signals, e.g. those emitted by the above memory controller or by the processor in question, may be directly relayed, i.e. without buffering, by a corresponding data buffer component (buffer) to the memory components 2a, 3a, 4a, 5a, 6a, 7a, 8a, 9a (e.g. via a (useful) data bus 21a directly connected with the above central memory bus 15a).

Correspondingly inverted, the (useful) data signals (data) emitted by the memory components 2a, 3a, 4a, 5a, 6a, 7a, 8a, 9a may also be relayed directly, without the inter-connection of a corresponding data buffer component (buffer), to the memory controller and/or to each processor (e.g. again via the above (useful) data bus 21a, which is directly connected with the central memory bus 15a).

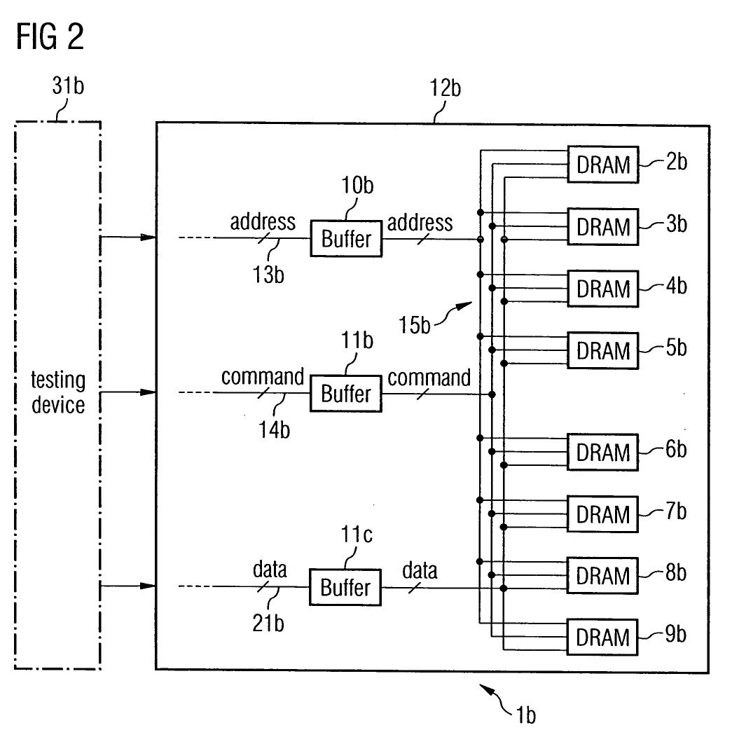

In FIG. 2 a schematic representation of a fully buffered memory module 1b (here: a “buffered DIMM” 1b) is shown.

FIG. 2, corresponding with the partially buffered memory module 1a as shown in FIG. 1, shows numerous memory components 2b, 3b, 4b, 5b, 6b, 7b, 8b, 9b and several data buffer components (“buffers”) 10b, 11b, 11c connected in series before the memory components 2b, 3b, 4b, 5b, 6b, 7b, 8b, 9b.

As is apparent from FIG. 2, the memory components 2b, 3b, 4b, 5b, 6b, 7b, 8b, 9b may be arranged on the same card 12b as the buffers 10b, 11b, 11c.

The memory module 1b may (correspondingly similar to the memory module 1a shown in FIG. 1), in particular with an inter-connected corresponding memory controller (not shown here and, e.g., arranged externally to the memory module 1b, in particular arranged externally to the above card 12), be connected with one or several micro-processors, particularly with one or several micro-processors of a server or work station computer (or any other suitable micro-processor, e.g. a PC, laptop, etc.).

As is apparent from FIGS. 1 and 2, the memory module 1b shown in FIG. 2 is correspondingly similarly and/or identically constructed with, and operates similarly or identically to the memory module 1a shown in FIG. 1, except that one or several additional data buffer components have been provided (here: an additional buffer 11c), with which correspondingly similar to conventional fully buffered memory modules (in addition to the control and address signals buffered by the buffers 10b, 11b) the (useful) data signals (data) exchanged between the memory controller, and/or each processor, and the memory components 2b, 3b, 4b, 5b, 6b, 7b, 8b, 9b, are also buffered.

In buffer 11c the corresponding data signals, e.g. those deriving from the memory controller, and/or from each processor, e.g. relayed via a data bus 21b, may be briefly retained and relayed in a chronologically coordinated, or where appropriate, in a multiplexed or de-multiplexed fashion to the memory components 2b, 3b, 4b, 5b, 6b, 7b, 8b, 9b (e.g. via a central memory bus 15b (corresponding with the above central bus 15a), as described in relation to FIG. 1.

Correspondingly inverted, in buffer 11c the data signals emitted by the memory components 2b, 3b, 4b, 5b, 6b, 7b, 8b, 9b to the above central memory bus 15b, may also be briefly-retained and relayed in a chronologically coordinated, or where appropriate in a multiplexed or de-multiplexed fashion to the memory controller and/or each processor (e.g. via the above data bus 21b).

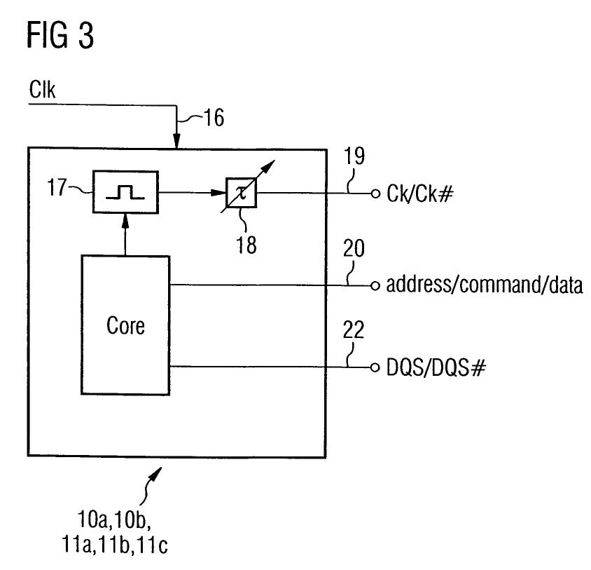

FIG. 3 shows, as an example, a schematic detail representation of a data buffer component and/or buffer 10a, 11a and/or 10b, 11b, 11c, as used in the memory module 1a, 1b in terms of FIG. 1 and/or 2.

As is apparent from FIG. 3, one or several of the above buffers 10a, 11a and/or 10b, 11b, 11c (shown in FIG. 1 or 2) may be supplied (e.g. via a corresponding pulse line 16) with an external reference pulse signal (clk) or with corresponding, differentiated pulse signals clk, clk# (e.g. via two different pulse lines), e.g. from a pulse generator arranged externally to each memory module 1a, 1b and/or on each of the cards 12a, 12b.

Alternatively, the pulse generator may be arranged on the same memory module 1a, 1b and/or on the same card 12a, 12b as the memory components 2a, 3a, 4a, 5a, 6a, 7a, 8a, 9a, 2b, 3b, 4b, 5b, 6b, 7b, 8b, 9b and/or the buffers 10a, 11a, and/or 10b, 11b, 11c.

As illustrated in FIG. 3, a pulse signal CK internally used on the (fully and/or partially buffered) memory module 1a, 1b or correspondingly, a differentiated pulse signal CK, CK# (used internally on the memory module 1a, 1b) is generated from the external pulse signal (clk) at one or several of the buffers 10a, 11a and/or 10b, 11b, 11c shown in FIG. 1, in particular an internal pulse signal CK (CK#), chronologically coordinated in relation to the external pulse signal (clk).

As is apparent from FIG. 3, the internal pulse signal CK (and/or the internal pulse signal CK, CK#) may be emitted by a corresponding pulse signal generation device 17 of the buffers 10a, 11a and/or 10b, 11b, 11c, to one (or several) corresponding lines 19, and relayed to the corresponding memory components 2a, 3a, 4a, 5a, 6a, 7a, 8a, 9a, 2b, 3b, 4b, 5b, 6b, 7b, 8b, 9b (and in fact, during the normal operation of the memory modules 1a, 1b, emitted without any change and/or adjustment, in particularly without any delay, by a pulse signal adjustment device 18, not provided on conventional buffers and correspondingly activated during the test operation of the memory module 1a, as is more closely described below, i.e. in a fixed pre-determined chronological relation to an external pulse signal clk).

The signals emitted to a corresponding line 20 by each respective buffer (e.g. the address signals emitted by buffer 10a, 10b and relayed to the central memory bus 15a, 15b, the command signals emitted by buffer 11a, 11b and relayed to the central memory bus 15a, 15b, and the (useful) data signals emitted by buffer 11c) stand in a fixed, pre-determined chronological relation to the external pulse signal clk, and, during normal operation, (not however, as is more clearly explained further below, during the test operation of the memory modules 1a, 1b) to the internal pulse signal CK (and/or to the internal pulse signals CK, CK#) generated by the corresponding buffers 10a, 11a, 10b, 11b, 11c.

The data strobe signals (e.g. a signal DQS, and a signal DQS# inverted in relation to it) exchanged between corresponding lines 22 linking the memory components (similarly connected with the central memory bus) and a corresponding buffer (and/or directly to the memory controller/processor) serve to indicate when the (useful) data signals emitted by each memory component and/or buffer (or directly by the memory controller/processor) are present in a stable state, i.e. for the chronological coordination of the selection of the (useful) data present at the memory bus by the memory component, which is in communication with the respective buffer (and/or memory controller/processor), (and/or, conversely, for the chronological coordination of the selection of the (useful) data present at the memory bus by the buffer (and/or memory controller/processor)), which is in communication with the memory component.

Corresponding to the above address, control and (useful) data signals, the data strobe signals (DQS, DQS#) also stand in a fixed, predetermined chronological relation to the external pulse signal clk, and, during normal operation, (not however, as more closely illustrated below, during the test operation of the respective memory modules 1a, 1b) also to the internal pulse signal CK, generated by the corresponding buffer 10a, 11a, 10b, 11b, 11c (and/or to the internal pulse signals CK, CK#).

If, by means of a semiconductor component test procedure more closely described below, the functionality of the memory modules 1a, 1b shown in FIGS. 1 and 2 is tested, as is shown by a dotted line in FIGS. 1 and 2, a corresponding external test apparatus 31a, 31b may be connected with the memory modules (which can, e.g. via the above address, control and data buses 13a, 13b, 14a, 14b, 21a, 21b exchange corresponding address, control and data signals, instead of with the above memory controller and/or processors, with the buffers 10a, 10b, 11a, 11b, 11c and/or memory components 2a, 3a, 4a, 5a, 6a, 7a, 8a, 9a, 2b, 3b, 4b, 5b, 6b, 7b, 8b, 9b, and may make this or these external pulse signal(s) clk (and/or clk#) available to the memory module 1a, 1b, instead of to the above pulse generators, etc.)

Alternatively the function of the above, external, test apparatuses 31a, 31b can also be taken over by a component (e.g. by an appropriately designed and constructed buffer) installed on the respective memory module itself, i.e., instead of an externally controlled test process, an internal test process controlled by the memory module itself (a so-called “embedded” test) may be performed.

Below, as an example, an embodiment example of a test process controlled by the external test apparatuses 31a, 31b (or internally controlled) is more closely described:

In a first step, the corresponding memory module 1a, 1b (particularly the corresponding buffer) may be switched over from the above normal operation to test operation (test mode) by applying a corresponding signal, e.g. a suitable data model (particularly by the test apparatuses 31a, 31b).

Next, in a second step, (again e.g. by applying a corresponding signal, particularly a corresponding data model by the test apparatuses 31a, 31b) the pulse signal adjustment device 18 shown in FIG. 3, which, as described above, was correspondingly deactivated during the normal operation of the buffer, may be activated.

A DLL circuit (DLL=Delay Locked Loop) may e.g. be used as a pulse signal adjustment device 18, with which (in an activated state) the, internal, pulse signal CK (and/or the above equal but inverted internal pulse signals CK, CK#) emitted by the pulse signal generating device 17 of the respective buffer 10a, 11a and/or 10b, 11b, 11c, and generated from the external pulse signal clk, may have a, variably adjustable, positive or negative delay period τ imposed on it (which may for instance amount to a fraction of the time period of the high logic (or low logic) phase of the pulse signal CK (and/or CK#)).

Next, e.g. again controlled by the above test apparatuses 31a, 31b, by applying corresponding address and control signals to the above address and control bus 13a, 13b, 14a, 14b, and by applying corresponding (test) data, e.g. emitted by the test apparatuses 31a, 31b, to the above data bus 21a, 21b (correspondingly similar to normal operation), the corresponding test data can be stored in the memory components 2a, 3a, 4a, 5a, 6a, 7a, 8a, 9a, 2b, 3b, 4b, 5b, 6b, 7b, 8b, 9b (however with a more critical timing than during normal operation, due to the pulse signal CK, CK# being deliberately advanced or retarded by the above delay period τ in comparison with normal operation, and/or with the other signals (e.g. the address and control signals, the DQS and DQS# signals, etc emitted to the memory components by the buffers 10a, 10b, 11a, 11b via the lines 20 and the central memory bus 15a, 15b).

Subsequently, e.g. again controlled by the above test apparatuses 31a, 31b, and again by applying corresponding address and control signals to the above address and control bus 13a, 13b, 14a, 14b, the test data previously stored in the memory components may again be read out of the memory components and for instance relayed to the above test apparatuses 31a, 31b.

Advantageously, the above pulse signal adjustment device 18 shown in FIG. 3 may be previously deactivated again (e.g. by again applying corresponding signals, particularly corresponding data models from the test apparatuses 31a, 31b) (so that the internal pulse signal CK (and/or CK, CK#) is emitted without any delay during the reading of the test data from the memory components, and, as foreseen for normal operation, stands in the above fixed chronological relation to the external pulse signal clk, and to the other signals (e.g. the control and address signals, etc.)).

Next, e.g. again controlled by the above test apparatuses 31a, 31b, the test data stored in the memory components (during more critical chronological conditions than during normal operation, as described above and due to the delay period τ imposed on the internal pulse signal) may be compared with the test data, which has been read out.

If the read-out test data corresponds with the stored data, the function test will, for a particular delay period τ used during the storage of the test data, count as “passed”; if not, as “failed”.

Advantageously, the above storage and reading out of test data would be repeated in succession (i.e. the above test steps would be performed numerous times in succession), whereby the internal pulse signal, in each case emitted by the respective buffer during storage (and/or reading out), has in each case been respectively strongly retarded (in the positive or negative sense).

For instance, during a first test run, (e.g. controlled by the test apparatuses 31a, 31b) the pulse signal adjustment device 18, particularly the DLL circuit, may be so adjusted that the, internal, pulse signal CK (and/or the above equal but inverted internal pulse signal CK, CK#) generated by the pulse signal generating device 17 of the respective buffers 10a, 11a and/or 10b, 11b, 11c from the external pulse signal clk, has a first, relatively minor positive delay period +τ1 imposed thereon.

During a second test run (e.g. one controlled by the test apparatuses 31a, 31b) the pulse signal adjustment device 18, particularly the DLL circuit, may then be adjusted in such a way that it imposes a second, positive delay period +τ2 on the, internal, pulse signal CK, which delay is somewhat longer than the delay period +τ1 used during the first test run; during a third test run a third, positive delay period +τ3 may then be used, further increased in comparison with the second, positive delay period +τ2, etc., until one, or several successive, tests (with a delay period τ_{critical,+} allocated to the respective test in each case) counts, in terms of the description above, as “failed”; (the delay period τ_{critical,+} allocated to this test may be regarded as the “top” critical limit, and/or represents an upper measure of tolerance, particularly an upper input setup and/or input hold measure of tolerance for the respective tested memory module 1a, 1b).

Correspondingly similar, during a further test run, the pulse signal adjustment device 18, particularly the DLL circuit, may be adjusted in such a way that it imposes a further, in this case negative, relatively minor delay period, τ1 on the, internal, pulse signal CK, and, during a subsequent test run, imposes a negative delay period, τ2, which is (relatively) somewhat longer than the delay period τ1 used during the further test run etc., etc., until one, or several successive, tests (with a delay period τ_{critical,-} allocated to the respective test in each case) counts as “failed” in terms of the description above (the delay period τ_{critical,-} allocated to this test may be regarded as the “bottom” critical limit, and/or represents a lower measure of tolerance, particularly a lower input setup and/or input hold measure of tolerance for the respective tested memory module 1a, 1b).

Advantageously the above test procedure may be performed for numerous memory modules (e.g. for numerous mass produced memory modules of one and the same series), correspondingly similarly or identically constructed to the memory modules 1a, 1b shown in FIGS. 1 and 2, i.e. a corresponding serial test can be undertaken.

Preferably, even during the serial tests, the tolerance parameters τ_{critical,-} and/or τ_{critical,+} measured for the respective memory modules may be subjected to a suitable assessment.

In this way a corresponding parameter drift may be identified in time, whereupon suitable remedial measures may, in good time, be instituted (e.g. in the shape of an adjustment to and/or modification of the process parameters applied during the manufacture of the components/modules).

What is claimed is:

1. A semiconductor component test procedure for testing a memory module having at least one memory component with series-connected buffers, comprising:
testing the memory module by using a pulse signal chronologically advanced or retarded by a predetermined time period in comparison with the memory module during normal operation.

2. The process according to claim 1, wherein the pulse signal is generated by the buffers from a reference pulse signal.

3. The process according to claim 2, whereby the pulse signal is relayed to the memory component by the buffers.

4. The process according to claim 1, whereby the buffers may be switched over from a normal operating mode to a test operating mode.

5. The process according to claim 4, whereby the buffers include a pulse signal adjustment device which causes the pulse signal in the test operating mode to be chronologically advanced or retarded in comparison with the normal operating mode by the predetermined time period.

6. The process according to claim 1, further comprising:
testing the memory modules by using pulse signals chronologically advanced or retarded by a second predetermined time period in comparison with the memory module during normal operation, whereby the second, predetermined time period differs from the first predetermined time period used during step.

7. The process according to claim 1, whereby the memory module is tested repeatedly by using a predetermined pulse signal which has been chronologically advanced or retarded in comparison with the memory module during normal operation by respectively varying time periods.

8. A data buffer component connectable in series before a memory component, comprising:
a device for generating a pulse signal, the device capable of being switched over from a normal operating mode to a test operating mode, whereby the pulse signal in the test operating mode has been chronologically advanced or retarded in comparison with the normal operating mode by a predetermined time period.

9. The data buffer component according to claim 8, further comprising a device for chronologically varying the pulse signal in the test operating mode.

10. The data buffer component according to claim 9, wherein the device for chronologically varying the pulse signal contains a DLL circuit when in the test operating mode.
